(19) United States
(12) Patent Application Publication
(10) Pub. No.: US 2024/0365702 A1
(43) Pub. Date: Nov. 7, 2024

(54) Air Seeder Row Units, Seeding Implements, and Related Methods

(71) Applicant: PRECISION PLANTING LLC, Tremont, IL (US)

(72) Inventor: William Frank, Manito, IL (US)

(21) Appl. No.: 18/552,730

(22) PCT Filed: Apr. 5, 2022
(86) PCT No.: PCT/IB2022/053165

§ 371 Date: Sep. 27, 2023

Related U.S. Application Data
(60) Provisional application No. 63/187,069, filed on May 11, 2021.

(51) Int. Cl. A01C 21/00; A01B 76/00; A01C 5/06; A01C 15/00; G01L 5/00

(52) U.S. Cl. CPC A01C 21/00; A01B 76/00; A01C 5/064; A01C 5/068; A01C 15/005; G01L 5/0038

(57) ABSTRACT

An air seeder row unit includes a bracket configured to be attached to a frame of an air seeder, a support arm pivotally coupled to the bracket, a force device pivotally connected to the bracket and to the support arm, and a load sensor disposed adjacent the force device and configured to measure a load of the force device on the support arm. The support arm carries an opener disc and a gauge wheel, and the opener disc is configured to open a seed trench in a soil surface as the row unit travels in a forward direction of travel. An agricultural seeding implement includes a frame configured to be pulled through an agricultural field with a plurality of such row units coupled to the frame. Related methods are also disclosed.

### CROSS-REFERENCE TO RELATED APPLICATION

This application claims the benefit of the filing date of U.S. Provisional Patent Application 63/187,069, “Air Seeder Row Units, Seeding Implements, and Related Methods,” filed May 11, 2021, the entire disclosure of which is incorporated herein by reference.

### FIELD

Embodiments of the present disclosure relate generally to agricultural row units, and in particular to air seeder row units having load sensors.

### BACKGROUND

It is well known that seeds may be planted in a field using air seeder row units carried by an implement. Opener discs form trenches in the field, and gauge wheels limit how deep the trenches can be formed. Load sensors may be used to measure the force of the gauge wheels on the ground, which is used to determine whether the opener discs are at the proper depth. However, because different row units have different designs, load sensors are designed to fit particular row units. One sensor may not be compatible with row units built by other manufacturers, or even other row units built by the same manufacturer.

### BRIEF SUMMARY

In some embodiments, an air seeder row unit includes a bracket configured to be attached to a frame of an air seeder, a support arm pivotally coupled to the bracket, a force device pivotally connected to the bracket and to the support arm, and a load sensor disposed adjacent the force device and configured to measure a load of the force device on the support arm. The support arm carries an opener disc and a gauge wheel, and the opener disc is configured to open a seed trench in a soil surface as the row unit travels in a forward direction of travel.

In further embodiments, an agricultural seeding implement includes a frame configured to be pulled through an agricultural field, with a plurality of such row units coupled to the frame.

A method of operating an agricultural seeding implement includes measuring a load of a force device of an air seeder row unit on an implement frame, and comparing the measured load to a threshold to determine a position of a gauge wheel of the implement relative to ground.

### BRIEF DESCRIPTION OF THE DRAWINGS

While the specification concludes with claims particularly pointing out and distinctly claiming what are regarded as embodiments of the present disclosure, various features and advantages may be more readily ascertained from the following description of example embodiments when read in conjunction with the accompanying drawings, in which:

FIG. 1 is a simplified side view illustrating an air seeder row unit;

FIG. 2 is a simplified side view illustrating another air seeder row unit;

FIG. 3 is a simplified top view illustrating a tractor drawing an agricultural implement carrying air seeder row units, such as those shown in FIGS. 1 and 2;

FIG. 4A is a simplified front view of a load sensor on the row units of FIGS. 1 and 2;

FIG. 4B is a simplified side view of the load sensor of FIG. 4A; and

FIG. 5 is a simplified flow chart illustrating a method of operating an agricultural seeding implement.

### DETAILED DESCRIPTION

The illustrations presented herein are not actual views of any row unit, air seeder, or portion thereof, but are merely idealized representations to describe example embodiments of the present disclosure. Additionally, elements common between figures may retain the same numerical designation.

The following description provides specific details of embodiments. However, a person of ordinary skill in the art will understand that the embodiments of the disclosure may be practiced without employing many such specific details. Indeed, the embodiments of the disclosure may be practiced in conjunction with conventional techniques employed in the industry. In addition, the description provided below does not include all elements to form a complete structure or assembly. Only those process acts and structures necessary to understand the embodiments of the disclosure are described in detail below. Additional conventional acts and structures may be used. The drawings accompanying the application are for illustrative purposes only, and are thus not drawn to scale.

As used herein, the terms “comprising,” “including,” “containing,” “characterized by,” and grammatical equivalents thereof are inclusive or open-ended terms that do not exclude additional, unrecited elements or method steps, but also include the more restrictive terms “consisting of” and “consisting essentially of” and grammatical equivalents thereof.

As used herein, the term “may” with respect to a material, structure, feature, or method act indicates that such is contemplated for use in implementation of an embodiment of the disclosure, and such term is used in preference to the more restrictive term “is” so as to avoid any implication that other, compatible materials, structures, features, and methods usable in combination therewith should or must be excluded.

As used herein, the term “configured” refers to a size, shape, material composition, and arrangement of one or more of at least one structure and at least one apparatus facilitating operation of one or more of the structure and the apparatus in a predetermined way.

As used herein, the singular forms following “a,” “an,” and “the” are intended to include the plural forms as well, unless the context clearly indicates otherwise.

As used herein, the term “and/or” includes any and all combinations of one or more of the associated listed items.

As used herein, spatially relative terms, such as “beneath,” “below,” “lower,” “bottom,” “above,” “upper,” “top,” “front,” “rear,” “left,” “right,” and the like, may be used for ease of description to describe one element's or feature's relationship to another element(s) or feature(s) as illustrated in the figures. Unless otherwise specified, the spatially relative terms are intended to encompass different orientations of the materials in addition to the orientation depicted in the figures.

As used herein, the term “substantially” in reference to a given parameter, property, or condition means and includes to a degree that one of ordinary skill in the art would understand that the given parameter, property, or condition is met with a degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” used in reference to a given parameter is inclusive of the stated value and has the meaning dictated by the context (e.g., it includes the degree of error associated with measurement of the given parameter).

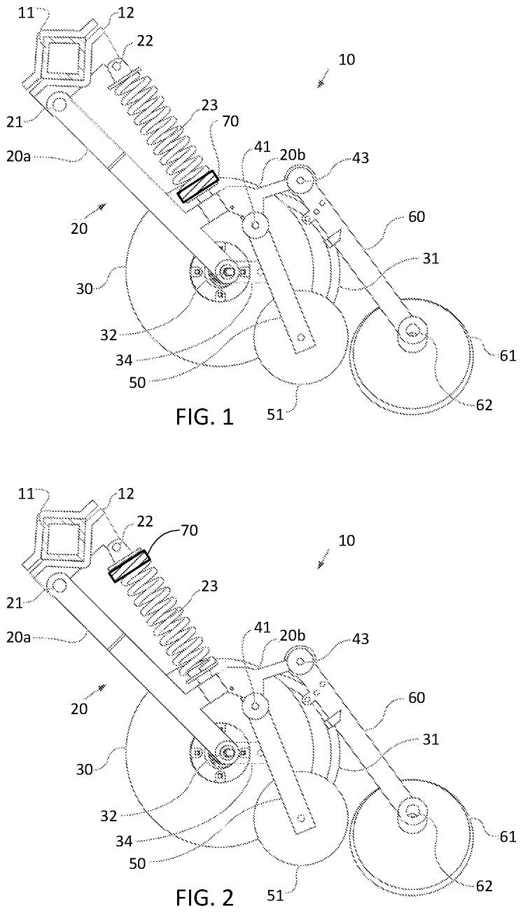

FIG. 1 is a simplified side view illustrating an air seeder row unit 10. The row unit 10 includes a bracket 12 configured to be attached to a frame 11 (e.g., a toolbar) of an agricultural implement. A support arm 20 is pivotally coupled to the bracket 12 at a pivot 21. The support arm 20 carries an opener disc 30 at axle 32, and gauge wheel 31 on a gauge wheel arm 34. The position of the gauge wheel 31 is typically fixed relative to the opener disc 30, such that when the gauge wheel 31 is in contact with the ground, the opener disc 30 forms a trench of a preselected depth.

A force device 23 is pivotally connected to the bracket 12 at pivot 22 and to the support arm 20. A firming implement support arm 50 may be pivotally connected to the support arm 20 at pivot 41, and may carry a firming implement 51. A closing wheel support arm 60 may be pivotally connected to the support arm 20 at pivot 43, and may carry a closing wheel 61 via an axle 62.

The support arm 20 may include a first portion 20a and a second portion 20b that extends away from the first portion 20a. While typically formed as a unitary piece, the support arm 20 can be made from two separate portions 20a and 20b connected together.

The row unit 10 may include a load sensor 70 disposed adjacent to and configured to measure the load (force) applied by the force device 23 on the support arm 20. For example, and as shown in FIG. 1, the load sensor 70 may be located at the end of the force device 23 adjacent the bracket 12. In some embodiments, and as shown in FIG. 2, the load sensor 70 may be located at end of the force device 23 adjacent the support arm 20.

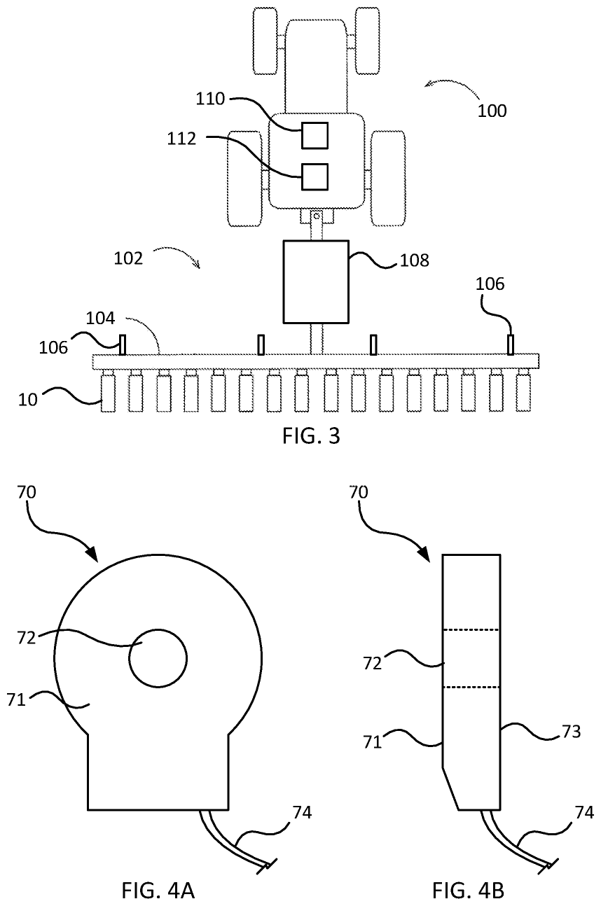

FIG. 3 is a simplified top view illustrating a tractor 100 drawing an agricultural implement 102 having a frame comprising a drawbar 104 supporting the air seeder row units 10 shown in FIGS. 1 and 2. The drawbar 104 may be supported by one or more wheels 106 or other supports. The frame of the implement 102 may carry a product tank 108, which may typically carry seeds to be planted by the row units 10. In operation, the seeds from the product tank 108 are conveyed to each of the row units 10.

The tractor 100 may have an implement monitor 110, which may include a central processing unit (“CPU”), memory, and graphical user interface (“GUI”) (e.g., a touch-screen interface), is typically located in the cab of the tractor 100, but may be located elsewhere. A global positioning system (“GPS”) receiver 112 may be mounted to the tractor 100 and connected to communicate with the monitor 110.

FIG. 4A is a simplified front view of the load sensor 70 alone, and FIG. 4B is a simplified side view. In FIG. 4A, a front face 71 is shown with a through-hole 72. As shown, the load sensor 70 may be a “pancake” compression cell configured to measure a compressive force along an axis thereof (e.g., forces acting on the front face 71 and an opposite rear face 73, shown in FIG. 3B). The through-hole 72 may be configured to receive an alignment member of the force device 23 (e.g., an alignment pin, a piston rod, etc.).

The load sensor 70 may generate a signal related to the load applied on the front face 71 and the rear face 73. The load sensor 70 may include a wiring harness 74 configured to transmit the signal generated by the load sensor 70 to a data system, such as the monitor 110 shown in FIG. 3 or a data system associated with the row unit 10.

The wiring harness 74 may include a CAN (Controller Area Network) processor to enable direct communication by the load sensor 70 over a CAN network. The CAN processor can communicate pressure readings and provide control signals over the CAN network. Alternatively, the load sensor 70 can be connected to a control module (either an on-row module, or a module controlling a plurality of row units) to communicate load measurements that are then processed by the control module.

The load sensor 70 may be used to measure the load applied to the row unit 10, which includes the sum of the loads applied to all the ground-engaging elements (e.g., the opener disc 30, the gauge wheel 31, the firming implement 51, and the closing wheel 61).

In a conventional row unit, loads may be measured by a load sensor coupled to the gauge wheel. Such a measurement may be used to ensure that there is sufficient force to push the gauge wheel into contact with the ground while the opener disc opens a trench. That is, if a nonzero force is measured on the gauge wheel, the gauge wheel is in contact with the ground, and the opener disc is determined to be operating at a selected depth. Such a load sensor does not measure depth of the opener disc, but by measuring the force on the gauge wheel, the position of the gauge wheel (and therefore the position of the opener disc) can be determined. That is, if a nonzero force on the gauge wheel is measured, the gauge wheel is on the ground, and the opener disc is in the ground at the selected depth.

The load sensor 70 may be used on a row unit 10 of any design and manufacture, and is not dependent on the configuration of the connection of the gauge wheel 31 relative to the support arm 20. Instead, the load sensor 70 may be placed between the force device 23 and the support arm 20 or between the force device 23 and the bracket 12. Thus, any row unit 10 may be retrofitted with the load sensor 70.

Though the load sensor 70 does not measure the force on the gauge wheel 31 directly, the total force on the ground-engaging elements may be used as a proxy. That is, if the measured force on the load sensor 70 exceeds a preselected threshold, a control system may presume that the gauge wheel 31 is in contact with the ground.

In some embodiments, another sensor may measure the force on the gauge wheel 31. For example, on an air seeder having many row units 10, each of the row units 10 may have load sensors 70 as shown in FIG. 1 or FIG. 2. One or a few of the row units 10 may also include an additional sensor configured to measure the force on the gauge wheel 31. The control system may use information from these additional sensors and from the load sensors 70 to determine the total of the approximate forces on the other ground-engaging elements of the row unit 10 (e.g., the opener disc 30, the firming implement 51, and the closing wheel 61). If the force measured by the load sensors 70 of the other row units 10 (i.e., those row units 10 on which the force on the gauge wheel 31 is not measured) exceeds this total, the gauge wheels 31 of those row units can be determined to be in contact with the ground. Thus, the trench depth can be determined to be at the preselected value.

An advantage of the load sensors 70 over conventional load sensors on the gauge wheels alone is that the load sensors 70 can easily be applied to various designs of row units. Thus, a single part number may be stocked by a supplier for use on different models of row units. This may enable efficiencies in manufacturing and distribution that yield lower costs and increased reliability (e.g., because parts can more easily be kept in stock).

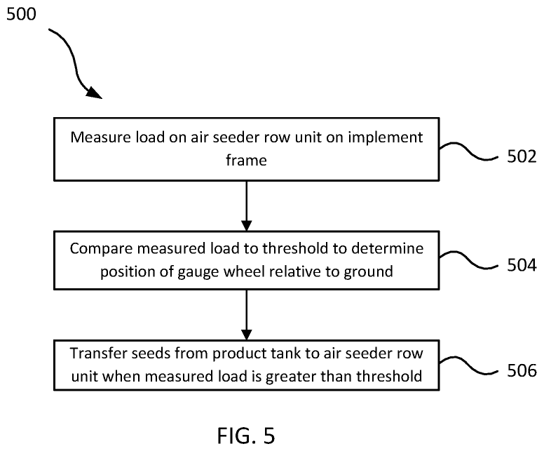

FIG. 5 is a simplified flow chart illustrating a method 500 of using the implement 102 with row units 10 to seed an agricultural field. In block 502, the method includes measuring a load of a force device of an air seeder row unit on an implement frame. This load may be measured with a load cell adjacent a force device that applies a force from the frame to the row unit, and thus, may measure the total force on the row unit by the frame.

As indicated in block 504, the method 500 includes comparing the measured load to a threshold to determine a position of a gauge wheel of the air seeder relative to the ground. The threshold may be selected such that when the measured load exceeds the threshold, the opener disc is as deep into the ground as the gauge wheel will allow. That is, any force above the threshold may be borne by the gauge wheel.

Block 506 represents transferring seeds from a product tank to the air seeder row unit when the measured load is greater than the threshold (i.e., when the opener disc is fully engaged with the ground).

Though depicted as a flow chart, the actions in FIG. 5 may be performed concurrently, and in some embodiments, some actions may be omitted.

Additional non-limiting example embodiments of the disclosure are described below.

Embodiment 1: An air seeder row unit, comprising a bracket configured to be attached to a frame of an air seeder, a support arm pivotally coupled to the bracket, a force device pivotally connected to the bracket and to the support arm, and a load sensor disposed adjacent the force device and configured to measure a load of the force device on the support arm. The support arm carries an opener disc and a gauge wheel. The opener disc is configured to open a seed trench in a soil surface as the row unit travels in a forward direction of travel.

Embodiment 2: The air seeder row unit of Embodiment 1, wherein the load sensor comprises a compression cell.

Embodiment 3: The air seeder row unit of Embodiment 2, wherein the load sensor comprises a wiring harness configured to transmit a signal related to a load applied to the load sensor.

Embodiment 4: The air seeder row unit of any one of Embodiment 1 through Embodiment 3, further comprising a firming implement carried by the support arm.

Embodiment 5: The air seeder row unit of any one of Embodiment 1 through Embodiment 4, further comprising a closing wheel carried by the support arm.

Embodiment 6: An agricultural seeding implement, comprising a frame configured to be pulled through an agricultural field and a plurality of row units coupled to the frame. Each row unit comprises a bracket configured to be attached to the frame, a support arm pivotally coupled to the bracket, a force device pivotally connected to the bracket and to the support arm, and a load sensor disposed adjacent the force device and configured to measure a load of the force device on the support arm. The support arm carries an opener disc and a gauge wheel. The opener disc is configured to open a seed trench in a soil surface as the row unit travels in a forward direction of travel.

Embodiment 7: The agricultural seeding implement of Embodiment 6, wherein frame is supported by a plurality of support wheels.

Embodiment 8: The agricultural seeding implement of Embodiment 6 or Embodiment 7, further comprising a product tank carried by the frame, the product tank configured to deliver seeds to the row units.

Embodiment 9: The agricultural seeding implement any one of Embodiment 6 through Embodiment 8, further comprising an implement monitor in communication with the load sensor.

Embodiment 10: A method of operating an agricultural seeding implement, the method comprising measuring a load of a force device of an air seeder row unit on an implement frame, and comparing the measured load to a threshold to determine a position of a gauge wheel of the implement relative to ground.

Embodiment 11: The method of Embodiment 10, wherein measuring a load of a force device of an air seeder row unit on an implement frame comprises measuring a total force of the air seeder row unit on the frame.

Embodiment 12: The method of Embodiment 10 or Embodiment 11, further comprising transferring seeds from a product tank to the air seeder row unit when the measured load is greater than the threshold.

All references cited herein are incorporated herein in their entireties. If there is a conflict between definitions herein and in an incorporated reference, the definition herein shall control.

While the present disclosure has been described herein with respect to certain illustrated embodiments, those of ordinary skill in the art will recognize and appreciate that it is not so limited. Rather, many additions, deletions, and modifications to the illustrated embodiments may be made without departing from the scope of the disclosure as hereinafter claimed, including legal equivalents thereof. In addition, features from one embodiment may be combined with features of another embodiment while still being encompassed within the scope as contemplated by the inventor. Further, embodiments of the disclosure have utility with different and various machine types and configurations.

1. An air seeder row unit, comprising:
a bracket configured to be attached to a frame of an air seeder;
a support arm pivotally coupled to the bracket, the support arm carrying an opener disc and a gauge wheel, wherein the opener disc is configured to open a seed trench in a soil surface as the row unit travels in a forward direction of travel;
a force device pivotally connected to the bracket and to the support arm; and
a load sensor disposed adjacent the force device and configured to measure a load of the force device on the support arm.

2. The air seeder row unit of claim 1, wherein the load sensor comprises a compression cell.

3. The air seeder row unit of claim 2, wherein the load sensor comprises a wiring harness configured to transmit a signal related to a load applied to the load sensor.

4. The air seeder row unit of claim 1 further comprising a firming implement carried by the support arm.

5. The air seeder row unit of claim 1, further comprising a closing wheel carried by the support arm.

6. An agricultural seeding implement, comprising:
a frame configured to be pulled through an agricultural field; and
a plurality of the air seeder row units of coupled to the frame.

7. The agricultural seeding implement of claim 6, wherein frame is supported by a plurality of support wheels.

8. The agricultural seeding implement of claim 6, further comprising a product tank carried by the frame, the product tank configured to deliver seeds to the row units.

9. The agricultural seeding implement of claim 6, further comprising an implement monitor in communication with the load sensor.

10. A method of operating an agricultural seeding implement, the method comprising:
measuring a load of a force device of an air seeder row unit on an implement frame; and
comparing the measured load to a threshold to determine a position of a gauge wheel of the implement relative to ground.

11. The method of claim 10, wherein measuring a load of a force device of an air seeder row unit on an implement frame comprises measuring a total force of the air seeder row unit on the frame.

12. The method of claim 10, further comprising transferring seeds from a product tank to the air seeder row unit when the measured load is greater than the threshold.
